(19) United States
(12) Patent Application Publication
(10) Pub. No.: US 2025/0359579 A1
(43) Pub. Date: Nov. 27, 2025

(54) Food Waste Recycling

(71) Applicants: Norman Boyle, Candelo (AU); Nathan Boyle, Candelo (AU); Brad Stebbing, Dulwich Hill (AU)

(72) Inventors: Norman Boyle, Candelo (AU); Nathan Boyle, Candelo (AU); Brad Stebbing, Dulwich Hill (AU)

(21) Appl. No.: 18/851,761

(22) PCT Filed: Mar. 28, 2023
(86) PCT No.: PCT/AU2023/050227

§ 371 Date: Sep. 27, 2024

(30) Foreign Application Priority Data
Mar. 28, 2022 (AU) 2022900786

(51) Int. Cl. A23N 17/02; A23K 10/26; A23K 10/37; A23K 30/20; A23N 17/00

(52) U.S. Cl. CPC A23N 17/02; A23K 10/26; A23K 10/37; A23K 30/20; A23N 17/007

(57) ABSTRACT

Disclosed herein is a process for producing an animal feed having a defined nutritional profile from food waste. The process comprises accumulating successive batches of a plurality of food wastes that have been macerated and dehydrated, every batch of each of the plurality of food wastes having been sourced from the same one of a plurality of categorized producers of food waste and maintained separately at all times from others of the plurality of food wastes; independently mixing each of the accumulated batches of the macerated and dehydrated food wastes to produce a plurality of homogenized ingredients for an animal feed; analysing each of the homogenized ingredients to determine one or more nutritional parameters of the ingredient; and blending two or more of the homogenized ingredients to produce the animal feed having a defined nutritional profile.

### TECHNICAL FIELD

The present invention relates to processes, methods and apparatus for use in the recycling of food waste and, in particular, for the recycling of food waste into premium animal feed.

### BACKGROUND ART

Almost a third of food produced for human consumption is reportedly wasted, at enormous economic and environmental cost. Disposing of food waste on a commercial scale has become increasingly problematic, as it is generally no longer acceptable to send all food waste to landfill. Many ingenious solutions have been proposed to the food waste problem, however few of these solutions have realised commercial success.

In one of such solutions, one of the present inventors made an invention relating to a unique method for recycling food waste. This invention is described in international (PCT) application no. PCT/AU2017/051130, the content of which is hereby incorporated in its entirety into this specification. In realizing this invention on a commercial scale, however, additional problems became apparent.

### SUMMARY OF INVENTION

The present invention relates generally to apparatus, processes and methods for recycling food waste for maximum environmental and economic benefits, as is the case, for example, when food waste is used to produce a premium animal feed. As will become apparent from the disclosure set out below, the overarching purpose of the present invention is to enable practically any food waste to be recycled into a vendable product with little to no wastage. The environmental benefits of the present invention are significant, both in terms of reducing the amount of food waste sent to landfill and in enabling products such as premium animal feed to be produced without having to use other sources of ingredients (e.g. grain and sources of protein) that might be more beneficially used as human food.

In a first aspect, the present invention provides a process for producing an animal feed having a defined nutritional profile from food waste. The process comprises accumulating successive batches of a plurality of food wastes that have been macerated and dehydrated, every batch of each of the plurality of food wastes having been sourced from the same one of a plurality of categorized producers of food waste and maintained separately at all times from others of the plurality of food wastes; independently mixing each of the accumulated batches of the macerated and dehydrated food wastes to produce a plurality of homogenized ingredients for an animal feed; analysing each of the homogenized ingredients to determine one or more nutritional parameters of the ingredient; and blending two or more of the homogenized ingredients to produce the animal feed having a defined nutritional profile.

As described in PCT/AU2017/051130, the inventor discovered that certain categories of food wastes can be processed to produce ingredients for animal feeds that have a relatively consistent nutritional profile. For example, food wastes from bakeries, cafés and butchers, can be processed separately to produce ingredients having different nutritional profiles for a resultant animal feed. Such ingredients provide for a myriad of blending opportunities for producing animal feeds having nutritional contents that enable them to command a premium price.

The invention the subject of PCT/AU2017/051130 has been successfully performed and has resulted in the production of animal feeds such as chicken feed, prawn feed and fish feed. The inventors discovered, however, that there are slight variations between batches of the categorised food wastes, even if taken from exactly the same producer of the food waste. In some applications, these variations may be tolerable. However, premium animal food products (e.g. chicken feeds) have very exacting requirements, and these variations are not compatible with such food products. The homogenisation, analysis and blending steps in the process of the present invention have been found to provide an elegant solution to this problem. The process of the present invention enables the production of animal feeds having precisely defined nutritional profiles from food waste. Further, given the variety of food waste sources which can be utilised, the ingredients produced in the course of the present invention have a correspondingly diversity of nutritional parameters. Such a diverse feedstock of immediately available ingredients provides a great number of blending opportunities for producing animal feed having practically any given composition. Indeed, in some embodiments, animal feeds meeting exacting criteria (e.g. chicken feed) can be produced without the requirement for any ingredients other than those obtained from the food wastes. The benefits in terms of cost and guaranteed supply of ingredients are immediately apparent.

In a second aspect, the present invention provides a method for dehydrating a macerated food waste. The method comprises mixing into the macerated food waste, proximal to an inlet of a dehydrator, a material having a moisture content that is different to a moisture content of the macerated food waste, wherein the added material and the macerated food waste are mixed such that the mixture at the inlet of the dehydrator has a defined and substantially homogeneous moisture content. The mixture can subsequently be dehydrated.

In a third aspect, the present invention provides an apparatus for dehydrating a macerated food waste. The apparatus comprises a hopper, an outlet of the hopper reporting to an inlet of a dehydrator; a moisture detector configured to detect a moisture content proximal to the outlet of the hopper; a conduit via which a material having a moisture content that is different to the moisture content of the macerated food waste can be added to the macerated food waste proximal to the outlet of the hopper; and a mixer for mixing the material and the macerated food waste in a manner whereby the resultant mixture presents to the inlet of the dehydrator having a defined and substantially homogeneous moisture content.

The second and third aspects of the invention advantageously overcome problems associated with dehydrating macerated food wastes that have variable water contents or which are either too wet or (less commonly) too dry. Once fed into the dehydrators used in the inventors' trials, the macerated food waste is quickly broken up into smaller particles. Particles that are relatively dry may be damaged due to excessive heat, whilst particles that are relatively wet may not sufficiently dehydrate.

In these aspects of the invention, however, the blending of a second (usually drier) material into the macerated food waste at a specific location in the hopper ensures that an appropriate mixing takes place and that the material presenting to the dehydrator has both a relatively consistent moisture content, as well as a target moisture content (e.g. 50% moisture). The dehydrator can thus be operated to dehydrate the entity of the mixture, with a reduced risk of any damage to the material occurring. As would be appreciated, excess heat can be detrimental to the nutritional content of many categories of food.

In a fourth aspect, the present invention provides a method for producing a dehydrated granular powder from a macerated food waste. The method comprises dehydrating the macerated food waste to produce a dehydrated product and then agitating the dehydrated product as it cools, such that clumping is prevented and the dehydrated granular powder is produced.

Advantageously, this aspect of the invention has been found to prevent the clumping together of the granular particles of food wastes that can occur as some categories of food waste cool (this has been found to be a particular problem when processing food waste streams that have a relatively high fat content).

In some embodiments, the method of the fourth aspect may also include a biosecurity treatment. For example, the method may include a biosecurity treatment comprising maintaining the dehydrated product produced in the dehydrator at a temperature of at least 100° C. for a period of at least 30 minutes. Heating to this temperature and for this time will ensure that any pathogens (e.g. microorganisms and viruses) that may be present in the dehydrated granular powder have been killed. Post-processing, the dehydrated granular powder is entirely biosecure and thus will not be a source of bacterial, viral, fungal or any other pathogenic contamination, any of which are undesirable in an industrial environment or might cause downstream spoilage. The biosecure granular powders of macerated and dehydrated food wastes produced by this method are shelf-stable and pathogen-free and can thus be stored for longer periods of time without spoilage issues.

In a fifth aspect, the present invention provides a macerator assembly comprising a macerator having an inlet and an outlet, the inlet being coupleable with an outlet of a storage container and where the macerator can be moved between a plurality of storage containers.

Such a macerator assembly advantageously reduces capital costs for industrial applications of the invention and enables efficiencies that might not otherwise be obtainable.

Additional features and advantages of the various aspects of the present invention will be described below in the context of specific embodiments. It is to be appreciated, however, that such additional features may have a more general applicability in the present invention than that described in the context of these specific embodiments.

### BRIEF DESCRIPTION OF DRAWINGS

Embodiments of the present invention will be described in further detail below with reference to the following drawing, in which:

FIG. 1 shows a schematic overview of a process for producing an animal feedstock from a plurality of categorised waste streams and which incorporates various embodiments of the present invention.

### DESCRIPTION OF EMBODIMENTS

As noted above, the present invention relates to a process via which an animal feed can be produced from a number of separately collected, maintained and processed categorised food wastes.

As used herein, the term “food waste”, and the like, is intended to encompass all kinds of food wastes, including (but not limited to) coffee grounds, vegetable matter, dairy products, bakery waste, meat off-cuts and bones, and seafood shells (e.g. oysters, mussels, lobsters, etc.).

As used herein, the term “food waste producers”, “producers of food waste” and the like, is intended to encompass any establishment that produces an appropriate quantity of food waste on a regular basis. Food waste producers include, but are not limited to, restaurants, cafes, pubs/clubs, retirement homes, hospitals, supermarkets, grocers, greengrocers, delicatessens, butchers and bakeries.

As used herein, the terms “categories of food waste”, “categorised producers of food waste” and the like, relate to distinct streams of food wastes and sources of these wastes which, because of their common origin, will have a relatively consistent composition between successive batches. Categories of food wastes include those described immediately above, which are produced by the respective food waste producers described in the preceding paragraph. By way of example, one category of food waste may be bread products (obtained as waste from a bakery) and another category of food waste, to be collected, maintained and processed separately from the bakery waste, may be meat offcuts (obtained as waste from a butcher).

In its first aspect, the present invention provides a process for producing an animal feed having a defined nutritional profile from food waste. The process comprises accumulating successive batches of a plurality of food wastes that have been macerated and dehydrated, every batch of each of the plurality of food wastes having been sourced from the same one of a plurality of categorized producers of food waste and maintained separately at all times from others of the plurality of food wastes; independently mixing each of the accumulated batches of the macerated and dehydrated food wastes to produce a plurality of homogenized ingredients for an animal feed; analysing each of the homogenized ingredients to determine one or more nutritional parameters of the ingredient; and blending two or more of the homogenized ingredients to produce the animal feed having a defined nutritional profile.

In the present invention, food wastes are categorised based on their source. The nutritional characteristics of food waste collected from producers of different types of food wastes would be expected to vary quite significantly. Bakers, for example, would produce food waste that would be unlikely to be as high in protein content as would waste from a butcher, for example. It was discovered, however, that categories of food waste collected only from bakeries (and the like) and processed independently of other categories of food wastes resulted in a processed food waste having remarkably consistent nutritional profiles between batches. Similarly, food wastes collected from sources such as restaurants/cafes, greengrocers or butchers all have relatively consistent nutritional profiles between batches. Each of these categories of food waste can therefore be combined (i.e. with other batches of the same categories of food waste—e.g. that collected a day later from the same source) and processed independent of other categories of food wastes in order to produce a plurality of ingredients having different nutritional profiles. These ingredients enable a wide variety of blending opportunities, whereupon an animal feed having a bespoke nutritional content can be produced.

In contrast, in many prior art processed, food wastes are co-mingled and, when processed, result in an animal feed having a non-specific and highly batch variable nutritional content. Such animal feed, whilst providing nutrition for animals, simply cannot command a premium price.

As described above, the inventors have more recently discovered that there are slight variations between batches of categorised food wastes, even if taken from exactly the same producer of the food waste. Whilst such variations may be tolerable in some applications, premium animal food products (e.g. chicken feed) have very exacting requirements and variations in nutritional contents are simply not acceptable. The homogenisation, analysis and blending steps of the process described herein allow for the production of animal feeds having precisely defined nutritional profiles from food waste. Such products can command premium prices.

Advantageously, some embodiments of the process of the present invention may also result in zero waste, with all incoming food waste ending up in a final vendible product, such as an animal feed.

The process of the present invention includes accumulating successive batches of a plurality of categorised food wastes that have been macerated and dehydrated, each batch of each of the plurality of food wastes having been sourced from the same one of a plurality of categorized producers of food waste and maintained separately at all times from other categories of food waste. The categorized producers of food waste may, for example, be independently selected from restaurants, cafes, supermarkets, grocers, greengrocers, delicatessens, butchers, bakeries, etc.

Apparatus, methods and systems for collecting and separately maintaining a plurality of categories of food wastes are described in PCT/AU2017/051130 and will not be repeated here. Macerators and dehydrators for macerating and dehydrating products such as food waste are known, and specific examples of such are described below in the context of a preferred embodiment of the invention.

The process also includes independently mixing each of the accumulated batches of the macerated and dehydrated food wastes to produce a plurality of homogenized ingredients for an animal feed.

The accumulated batches of the macerated and dehydrated food wastes may be mixed at any convenient time. In some embodiments, for example, the accumulated batches may be mixed once an amount of the accumulated batches reaches a predetermined threshold. Alternatively, if an animal feed to be produced requires an ingredient having a nutritional profile that is likely to be provided by a particular category of food waste, then any accumulated batches of that food waste may be processed immediately to produce the respective homogenised ingredient (albeit likely in a lower quantity than the preceding embodiment). Mixing may occur in any suitable apparatus.

Given that the macerated and dehydrated food wastes typically presents as a granular powder, pneumatic conveying may conveniently be used to transfer materials between the storage vessels for the macerated and dehydrated food wastes and for the homogenized ingredients, and vice versa. Indeed, pneumatic conveying may conveniently be used to transfer granular powders throughout any of the “dry” areas of the overall process.

The process also includes analysing each of the homogenized ingredients to determine one or more nutritional parameters of the ingredient. Any suitable apparatus may be used for such analysis, in which a sample having a prescribed weight or volume (e.g. 1L) of the homogenized ingredient is removed from the bulk material and taken to a laboratory (e.g. an on-site laboratory) for testing. Examples of nutritional parameters that may be determined include: protein content, fat content, amino acid content and specific gravity.

The process also includes blending two or more of the homogenized ingredients to produce an animal feed having a defined nutritional profile.

Typically, blending involves determining a relative quantity of each of the homogenized ingredients that are required in order to produce the animal feed having a defined nutritional profile. The analysis of each ingredients' nutritional properties can, for example, be entered into a computer system, along with a desired resultant nutritional content of the animal feed. The computer system can then process this information and provide an exact ratio (typically on a volume basis) of each ingredient that is required to produce the animal feed.

In some embodiments, it may be necessary to add micro ingredients to the blended homogenized ingredients, and this can be determined at this time also.

The resultant animal feed may be processed into any suitable form, compatible with its end use. In some embodiments, for example, the process may further comprise processing the blended homogenized ingredients into an animal feed in the form of pellets, flakes or mash.

In some embodiments, a homogenized ingredient may be recyclable back into the respective accumulated batches of the macerated and dehydrated food wastes. For example, if only a small amount of a particular homogenized ingredient remains after a production run of an animal feed, it may be more efficient to return this upstream in the process than to store it until it can be used in another animal feed which requires only a small amount of that ingredient. Returning the homogenized ingredient into the appropriate accumulated batch should not result in any significant change to the nutritional properties of that batch (it effectively being an “average” of those batches).

Typically, given the nature of food waste and the stringent requirements of animal feed, the food wastes that have been macerated and dehydrated will have also undergone a biosecurity treatment. Biosecurity treatments will be described in further detail below.

As will be appreciated, some of the animal feed produced in accordance with the present invention may contain meat products and therefore only be suitable for feeding animals that are able to eat potentially meat-containing animal feed. Animals that can eat such feed include most omnivores, such as chickens, ducks, game birds such as pheasants, and shellfish such as yabbies.

Whilst recycling food waste is a key feature in the present invention, the inventors note that it is possible to incorporate other edible material into the process, where doing so would not adversely affect the performance of the present invention. For example, products such as Maltings, Malt Combings, Hominy Meal or Mill Mix sold by Castlegate James may be used as the co-blending materials described below, or to contribute in some other advantageous way to the invention. Other edible products, such as micro ingredients for example, may also be incorporated at an appropriate stage of the process, should it be advantageous to do so.

In its second aspect, the present invention provides a method for dehydrating a macerated food waste (or, indeed, any moisture containing material). The method comprises mixing into the macerated food waste, proximal to an inlet of a dehydrator, a material having a moisture content that is different to a moisture content of the macerated food waste, wherein the added material and the macerated food waste are mixed such that the mixture fed into the dehydrator has a defined and substantially homogeneous moisture content.

As described above, mixing of a material (usually a relatively dry material) into the macerated food waste shortly before the resultant mixture is fed into a dehydrator ensures that the material presenting to the dehydrator has a relatively consistent moisture content throughout, as well as a moisture content appropriate for the dehydrator. The dehydrator can thus be operated to dehydrate the entity of the mixture, with particular efficiency and with a reduced risk of causing heat damage to the material.

As with the other aspects of the invention, the macerated food waste would typically have been sourced from one of a plurality of categorized producers of food waste and maintained separately at all times from other categories of food waste. Again, however, this need not be the case for all embodiments of this particular aspect of the invention.

The method comprises adding into the macerated food waste, proximal to an inlet of a dehydrator, a material having a moisture content that is different to a moisture content of the macerated food waste. Typically, a relatively dry material is added into a relatively wet macerated food waste, but this need not always be the case.

Any material may be added to the macerated food waste, bearing in mind the context of the invention. In some embodiments, for example, a stockpile of a previously dried material such as bread meal or spent brewer's grain may be maintained for this purpose. Commercially available products, such as those sold by Castlegate James and listed above, for example, may also be used, albeit at additional expense. Alternatively, a macerated and dried food waste from downstream in the process of the invention may be used, e.g. form the same category of food waste producer as for the macerated food waste headed into the dehydrator.

The quantity, relative moisture content and mixing technique will all affect the properties of the resultant mixture headed into the dehydrator. The quantity of the material added to the macerated food may, for example, be adjustable to achieve a specific moisture content. Similarly, a rate at which the material is added to the macerated food is adjustable to achieve a specific moisture content.

The method also comprises mixing the added material and the macerated food waste in a manner whereby the resultant mixture for feeding into the dehydrator has a defined and substantially homogeneous moisture content. Such mixing may be achieved using any conventional technique, and preferably one that results in compressing of the material into the macerated food waste, thus causing a rapid moisture exchange between the relatively wetter/drier materials. In the embodiments described herein, a screw auger is used to mix the added material and the macerated food waste, but other apparatus cold be used to similar effect.

The defined moisture content (i.e. of the mixture fed into the dehydrator) may be between about 5% and 80%, between about 20% and 70%, between about 30% and 60%, and more preferably at about 50% (w/w).

Dehydration of the mixture may be performed using any commercially available dehydrator. Many of the inventors' trials have been carried out using dehydrators sourced from AKT International and as described, for example in international (PCT) patent application no. PCT/AU89/00475, the content of which is hereby incorporated in its entirety into this specification.

Typically, dehydrating the mixture comprises agitating the mixture in a flow of hot air. Typically, the hot air has a temperature of about 350° C. and dehydration takes less than 10 seconds. A specific embodiment of a dehydrator will be described in further detail below.

In some embodiments, the method may further comprise measuring a moisture content of the dehydrated macerated food waste. Such a measurement can advantageously provide feedback for operational parameters of the dehydrator (e.g. the temperature of the dehydrator, the feed rate of material into the dehydrator and the residence time of the material in the dehydrator). For example, if a moisture content of the dehydrated granular powder exiting the dehydrator is deemed too high, then the operational parameters of the dehydrator can be adjusted (preferably automatically, by a computer-operated system that is controlling the process) to cause a greater amount of dehydration. Similarly, if a moisture content of the dehydrated granular powder exiting the dehydrator is deemed too low, then the operational parameters of the dehydrator can be adjusted to cause a lesser amount of dehydration.

The moisture content of the dehydrated particulate material exiting the dehydrator may be between about 1% and 12%. Materials having a moisture content above 12% are highly susceptible to microbial growth during storage. Preferably therefore, the dehydrated particulate material exiting the dehydrator has a moisture content below about 10% or about 8%. Materials having a moisture content below 8% are generally not susceptible to microbial growth during storage.

In a third aspect, the present invention provides an apparatus for dehydrating a macerated food waste (or, more generally, any moisture-containing material). The apparatus comprises a hopper, an outlet of the hopper reporting to an inlet of a dehydrator; a moisture detector configured to detect a moisture content of a material which is proximal to the outlet of the hopper; a conduit via which a material having a moisture content that is different to the moisture content of the macerated food waste can be added to the macerated food waste proximal to the outlet of the hopper; and a mixer for mixing the material and the macerated food waste in a manner whereby the resultant mixture presents to the inlet of the dehydrator having a defined and substantially homogeneous moisture content.

The apparatus of the third aspect is configured to perform the method of the second aspect, although is not so limited. In some embodiments, the apparatus may include additional features that enable it to perform any and all embodiments of the method.

The assembly includes a hopper, an outlet of which reports to an inlet of a dehydrator. Specific embodiments of the hopper and dehydrator will be described in further detail below.

The apparatus also includes a moisture detector configured to detect a moisture content of macerated food waste adjacent to the outlet of the hopper/inlet of the dehydrator. Moisture detectors such as the MCT460 Online Smart NIR Sensor Series produced by KPM Analytics are expected to be suitable for this purpose. In some embodiments, a detector configured to detect moisture may also be configured to detect other properties of the material under analysis. Such properties may include its fat and/or protein content. Whilst more expensive, moisture detectors providing such an enhanced functionality may provide advantages in performance of the invention.

The apparatus also includes a conduit via which a material having a moisture content that is different to the moisture content of the macerated food waste can be added to the macerated food waste proximal to the outlet of the hopper. The conduit may be provided in any suitable form, such as a pipe extending to the hopper, with its outlet being proximal to the hopper's outlet.

The apparatus also includes a mixer for mixing the material and the macerated food waste in a manner whereby the resultant mixture presents to the inlet of the dehydrator having a defined and substantially homogeneous moisture content. Again, any apparatus capable of providing this functionality, given the context of the invention, may be used for such mixing. In the embodiments described below for example, a screw auger is used for mixing the macerated food waste and other material as it is fed into the dehydrator. A person skilled in the art would recognise other suitable apparatus for this purpose.

In some embodiments, the apparatus may further comprise a second moisture detector configured to detect a moisture content of dehydrated macerated food waste exiting the dehydrator. Similar to that described above in the context of the second aspect, operational parameters of the dehydrator (e.g. temperature, material feed rate and residence time) may be adjusted based on the measured moisture content of the dehydrated macerated food waste exiting the dehydrator.

In a fourth aspect, the present invention provides a method for producing a dehydrated granular powder from a macerated food waste (or, indeed, other moisture containing materials). The method comprises dehydrating the macerated food waste to produce a (still warm/hot) dehydrated product and then agitating the dehydrated product as it cools. In this manner, clumping of the dehydrated product is prevented and the granular powder produced.

Advantageously, this aspect of the invention has been found to prevent clumping of granular particles of food wastes, which can occur as some categories of food waste cool down after being heated. Dehydrating the macerated food waste may be achieved using any suitable technique, such as those disclosed herein (although it will be appreciated that the invention is not so limited).

Post-dehydration, the still-warm dehydrated product is agitated as it cools, in a manner that prevents clumping of the product from occurring. In the embodiments described in further detail below, the dehydrated product cools in a screw auger, where it is constantly turned over by the screw whilst it moves through the (optionally cooled) sleeve. As would be appreciated, however, many other apparatuses could provide a similar functionality.

The cooled dehydrated granular powder typically has a particle size of between about 1-3 mm.

The inventor notes that clumping can occur with some dehydrated granular powders as they exit the dehydrator at temperatures of about 50-70° C. and start to cool down. This has been found to be more of a problem, however, in methods that also include a biosecurity step (described below), where higher temperatures and longer residence times are required.

The method of the fourth aspect may also include a biosecurity treatment prior to the dehydrated granular powder cooling step. Whilst a biosecurity step could be carried out at a different stage of the overall process, operational efficiencies are gained when still-warm material is presented to the biosecurity treatment.

Biosecurity of food products is of paramount importance when these are sold to a consumer, but such is less regulated when it comes to food waste. If food waste is to be used in the production of animal feed, however, then it is vital that it is biosecure, as many threats to animal welfare could present in unsafe feed. By way of example, such threats may include African swine fever, Aujeszky's disease and Brucella suis in pigs; arboviruses, avian adenovirus and avian Influenza in poultry; as well as foot and mouth disease in livestock.

In the biosecurity heat treatment, the material must be heated at a temperature and for a time effective to kill all pathogens (including all microorganisms such as bacteria and fungi) and all viruses. Biosecurity heating protocols may be governed by regulation, based on scientific evidence or empirical determination, but all result to total pathogen inactivation. The inventors have found that heating dehydrated granular powders of food waste for at least 30 minutes (e.g. 30-35 minutes) at a temperature of at least 100° C. (this being the temperature experienced by the powder, not necessarily the chamber temperature) is effective to kill all potential microorganisms. Higher temperatures may be used, but heating to such may adversely affect the nutrient content of the resultant biosecure product.

Once the biosecurity heat treatment has been conducted, the biosecure product is cooled. Relevant measurements may be taken at this time, such as the weight of the biosecure product. Cooling may occur naturally, due to exposure to ambient conditions, or may be controlled using a coolant (e.g. a cooled sleeve of an auger, as described above). Cooling may take an appropriate time, and would typically occur over a period of between about 3 to about 15 minutes.

The biosecurity treatment may be carried out in any suitable apparatus, such as a screw auger.

In a fifth aspect, the present invention provides a macerator assembly comprising a macerator having an inlet and an outlet. The inlet can be coupled with an outlet of a storage container and the macerator can be moved between a plurality of storage containers.

A specific embodiment of a macerator assembly will be described below. Generally speaking, however, the macerator assembly may include rails (or other moving apparatus, such as a conveyor belt) along which the macerator can slide into alignment with the outlet of one of the plurality of storage containers. The macerator assembly may also include a lifting assembly, for lifting the macerator such that the inlet couples with the outlet of one of the plurality of storage containers.

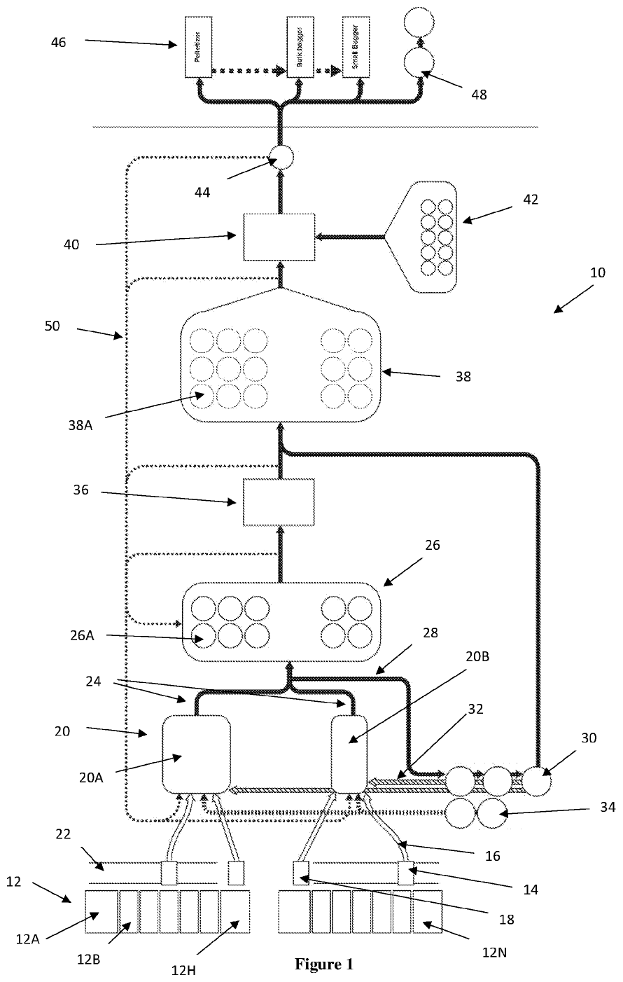

A specific embodiment of a process for producing an animal feedstock from a plurality of categorised food waste streams, and which incorporates various embodiments of the aspects of the present invention, will now be descried with reference to FIG. 1.

FIG. 1 is a schematic/flow diagram of a process 10 in which starting materials in the form of categorised food wastes are processed to produce an animal feed for sale to the market. Advantageously, the produced animal feed has a well-defined nutrient content, which has been matched to the requirements of the customer and can therefore command a high price. Furthermore, as the raw materials for this product are traditionally seen as a waste product, production costs should be significantly lower than for conventional animal feed manufacture. Finally, the environmental gains from beneficially using food waste to produce a vendible product are significant.

In FIG. 1, the following key is used:

Key

| | |
|---|---|
| [symbol] | Pneumatics (forwards) |
| [symbol] | Pneumatics (backwards) |
| [symbol] | Delicate material |
| [symbol] | Flexi auger |
| [symbol] | Wet pumped |
| [symbol] | Wet pumped |

In the process 10, categorised food wastes, collected, stored and transported as described in PCT/AU2017/051130, for example, are delivered to a bank of categorised food waste bins 12. Bins 12A to 12N are physically separated from each other and each receives the same category of food waste. By way of example, bin 12A may be designated to receive waste from bakeries, whilst bin 12B designated to receive waste from butchers, etc. As each successive delivery of recently collected food waste arrives, any bakery waste would be added to bin 12A and any meat waste added to bin 12B. As described in PCT/AU2017/051130, each of these categories of food waste will have a similar nutritional content.

Once each bin 12 reaches a pre-defined capacity (or after a predetermined period of time, bearing in mind the spoilage potential of food wastes), a macerator and pump assembly, shown generally as macerator 14, is used to macerate the food waste in a respective bin 12 and pump the macerated food waste via line 16 into a hopper (not shown) and, subsequently, a dehydrator 20. Macerator 14 sits on tracks 22, which enable it to move laterally underneath successive bins 12. In use, macerator 14 would be moved into a position next to a respective bin (e.g. bin 12A), where it can couple with an outlet (not shown) of the bin. Opening the outlet of the bin 12 causes the food waste in the bin to fall into the macerator 14, where it is macerated and subsequently pumped to the dehydrator 20. The macerator 14 may, for example, be lifted into a position where this coupling can occur, although other movements to the same effect could, of course, be performed.

A fixed macerator 18 may also be provided in communication with a designated bin (e.g. bin 12H). This macerator 18 may be especially configured for macerating larger or harder food wastes. For example, smaller macerators may not be able to engage relatively large articles such as whole cabbages or cauliflowers, and hence not be able to macerate them. Oyster shells or bones may also require a more robust macerator. Providing a dedicated macerator 18 for such relatively large food waste further improves the capacity of the process.

Once a respective bin 12 has been emptied, a wash down may occur. A small amount of water may be sprayed into the bin 12, washing down its walls and effectively cleaning it. The wash-water, in which any remaining food waste is entrained, may enter the macerator 14, and subsequently be pumped to the dehydrator 20.

The dehydrator 20 is operated under conditions that dehydrate the macerated food waste presented to it. In the dehydrators used by the inventors in their trials, which are described in PCT/AU89/00475, hot air (ca. 350° C.) is blown through a chamber into which the macerated food waste is introduced. Spinning arms dependent from a central shaft strike the macerated food waste, causing it to be further comminuted and propelled through the hot air. After as little as 10 seconds, a granular powder is formed in the drying chamber, which becomes entrained in the flow of air and is carried out of the chamber. A cyclone separator (not shown) is subsequently used to separate the granular particles from the hot air and moisture. The granular powder exits an air lock valve of the cyclone via dehydrator outlet line 24, and is further processed as described below.

In process 10, two dehydrators 20A and 20B are depicted, one being larger than the other, having a maximum output of about 1.5 m³/hour (20A) instead of about 1.0 m³/hour (20B). Dehydrators 20A and 20B can be independently operated separately or together, as required to maximise the overall efficiency of process 10.

Operation of the dehydrator 20 (dehydrators 20A and 20B both operate in the same manner) involves monitoring a number of parameters, many of which the inventors expect will be automatable. One of these parameters is the moisture content of the macerated food waste fed into the dehydrator 20, which is ideally around 50%. Dehydration is also more efficient when the material entering the dehydrator 20 has a relatively consistent moisture content, which is not always the case for food wastes. In order to better control the moisture content of the macerated food waste presenting to dehydrator 20 therefore, a dry co-blending operation described below may be used.

Dehydrated food waste in line 24 may be directed via line 28 into silos 30 for temporary storage. When comminuted food waste having a moisture content that is too high presents to the dehydrator 20, a quantity of the dehydrated food waste from silos 30 may be transferred via line 34, typically provides in the form of a flexi screw auger (not shown) into the hopper (not shown) for admixing with the comminuted food waste such that the resultant mixture which enters dehydrator 20 has a reduced and relatively consistent moisture content throughout.

The inventors also note that spent brewer's grain is a food waste containing a high amount of nutrients and which can be problematic to dispose of. As such a food waste does not need to be macerated, it can be stored separately in silos 34 and fed into the dehydrator 20 at an appropriate time (e.g. when there is no other food wastes in bins 12 to be dehydrated). The inventors note that dehydrated spent brewer's grain is also a suitable dry co-blending material and could be used exclusively for this purpose. Another food waste that would be useful as a co-blending material is bread meal. Other products which might be used include those sold by Castlegate James and described above, any of which could be stored in silos 30/34.

Dehydrated comminuted food waste that exits the dehydrator 20 may be further treated to ensure that it is biosecure. Such a treatment may be performed in the assembly described below. In the biosecurity heat treatment, the dehydrated granular powder must be heated at a temperature and for a time effective to kill all pathogens (including all microorganisms such bacteria and fungi) and all viruses. In this embodiment, the material is heated for at least 30 minutes (e.g. 30-35 minutes) at a temperature of at least 100° C. (this being the temperature experienced by the products, not necessarily the chamber temperature).

Heating occurs in a first screw auger (not shown), an inlet of which is configured to receive the dehydrated produce from line 24. Heaters around the auger's shaft cause the material inside to be heated to the desired temperature, and the screw turned at a rate whereby the residence time of the material in the auger is controlled. At the end of the biosecurity treatment, the biosecure granular powder cools and the inventors have found that this cooling should ideally be controlled in order to prevent clumping of the powder (this is particularly a problem for food wastes that are relatively high in fat or protein). The inventors have found that agitating the material whilst it cools prevents clumping from occurring, and results in a granular powder that is relatively easy to handle in downstream processes (it has a substantially homogeneous particle size and can be moved using pneumatic conveying techniques). In these embodiments, a second screw auger (not shown) is used, with the hot biosecure granular powder that exits the first auger falling directly into the second auger, where the cooling process starts. The cooling may occur naturally, or may be caused by an applied cooling (e.g. to the sleeve of the auger). Again, the cooling time is dependent on the rate at which the auger's screw turns. The inventors have found that the constant turning action of the screw is sufficient agitation to prevent clumping.

The categorized, dehydrated, comminuted and biosecure food waste is then transferred (e.g. via pneumatic conveying, all downstream steps in the process 10 being dry) to an array of silos 26. Each silo (e.g. silo 26A) in the array of silos 26 holds a defined category of dehydrated, comminuted and biosecure food waste, with successive batches of the same category of similarly processed food waste (i.e. sourced from the same category of food waste producer, e.g. a bakery) being added to the silo 26A. In this manner, a stratified mass of food waste accumulates in each silo 26A, ready for further processing in the manner described below.

Each successive batch of appropriately categorized and processed food waste transferred into a particular silo (e.g. silo 26A) will have a similar nutritional profile, being from the same source, albeit with slight batch variances. However, the nutritional profiles of the accumulated food wastes in other silos (e.g. silo 26B, etc.), being a different category of food waste and which was sourced from a different category of food waste producer (e.g. a butcher), will be significantly different.

Once the quantity of material in any given silo 26 (e.g. silo 26A) reaches a particular level (e.g. as determined by a weight of the silo or by sensors within the silo), the contents of the silo are pneumatically conveyed to batch mixer 36, where a vigorous mixing takes place that completely homogenises the material. The thus mixed material is pneumatically conveyed to a respective silo in an array of silos 38 (e.g. silo 38A), and now defines an ingredient or a feedstock material available for blending in order to produce an animal feed. A physical sample (e.g. about 1 L of the ingredient) is taken from one of silos 38 (e.g. silo 38A), and is analysed for parameters such as its protein content, fat content, moisture content, specific gravity and amino acid profile. The ingredient stored in each silo 38 is thus well-characterised in terms of the qualities that it would add to an animal feed.

Silos 38 thus contain a number of homogenous ingredients, all having a well-characterised nutritional profile and a physically similar form (i.e. dry granular particles). These ingredients are immediately available for blending together in order to produce a resultant animal feed. In order to do so, calculated proportions of a plurality of the ingredients from various of the silos 38 are pneumatically conveyed to batch mixer 40. If necessary, micro ingredients from silos 42 can also be added to batch mixer at this time, along with any other ingredients that may be required. Although not shown, the microingredients would usually each be stored in their own distinct silo 42, for maximum blending opportunities.

Batch mixer 40 homogenises the ingredients and any added micronutrients, thus producing an animal feed with the required specification. The animal feed thus produced is pneumatically conveyed to storage silo 44 (if necessary) and then subsequently onto a packaging facility 46. In the packing facility, the animal feed may be pelletized, if necessary, and bagged (either in bulk or small sized (e.g. 20 kg) bags). Alternatively, the animal feed may be loaded into silos 48 for storing until it is subsequently loaded on a truck for transport offsite (e.g. to a chicken farm that required bulk feed).

This is what the inventors believe is the primary advantage of this aspect of the present invention, that the process, using only recycled food wastes, results in a number of ingredients having significantly different nutritional profiles, and which are available for blending in order to produce a vendible product (e.g. an animal feed). The inventors had not previously contemplated that batch variations between successive deliveries of the same category of food waste might have a potentially detrimental effect when used to produce animal feeds, such as chicken feed, where any deviation form an exact nutritional profile is unacceptable, The homogenisation, analysis and blending steps described herein have, however, enabled the production of animal feeds having precise nutritional contents (as is required for feeds such as chicken feed) on demand and to practically any given requirement.

The process 10 also includes recycle lines 50, which can be used to recycle products in the process to any upstream stage of the process. For example, if only a small amount of an ingredient is in a particular silo 38, and this silo is needed for a new ingredient, then the residual ingredient could be pneumatically conveyed back to an appropriate silo 26, or even into back into the dehydrator 20, as a co-blending material, for example.

It will be appreciated that the present invention provides a number of new and useful advantages. For example, specific embodiments of the present invention may provide one or more of the following advantages:
less food waste is sent to landfill;
a vendible, high quality animal feed can be produced, at a relatively low ongoing cost (i.e. due to the relatively inexpensive supply of food waste ingredients) and potentially from only collected food waste;
a wide variety of food wastes can be processed to result in ingredients having a correspondingly wide variety of nutritional profiles, these ingredients being blendable to produce animal feeds having practically any nutritional profile;
recycle lines will help to utilise every single bit of food waste in the process; and
the environmental benefits of beneficially reusing food waste as ingredients for animal feed instead of having to soured commercial ingredients (which could otherwise be put to more beneficial use—e.g. as human food).

It will be understood to persons skilled in the art of the invention that many modifications may be made without departing from the spirit and scope of the invention. All such modifications are intended to fall within the scope of the following claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that any prior art publication referred to herein does not constitute an admission that the publication forms part of the common general knowledge in the art.

1. A process for producing an animal feed having a defined nutritional profile from food waste, the process comprising:
accumulating successive batches of a plurality of food wastes that have been macerated and dehydrated, every batch of each of the plurality of food wastes having been sourced from the same one of a plurality of categorized producers of food waste and maintained separately at all times from others of the plurality of food wastes;
independently mixing each of the accumulated batches of the macerated and dehydrated food wastes to produce a plurality of homogenized ingredients for an animal feed;
analysing each of the homogenized ingredients to determine one or more nutritional parameters of the ingredient; and
blending two or more of the homogenized ingredients to produce the animal feed having a defined nutritional profile.

2. The process of claim 1, wherein the blending comprises determining a relative quantity of each of the homogenized ingredients that are required in order to produce the animal feed having a defined nutritional profile.

3. The process of claim 1, wherein the one or more nutritional parameters of the ingredient are independently selected from one or more of the following: protein content, fat content, amino acid content and specific gravity.

4. The process of claim 1, wherein each of the accumulated batches of the macerated and dehydrated food wastes are mixed once an amount of the accumulated batch reaches a predetermined threshold.

5. The process of claim 1, wherein one or more of the homogenized ingredients are recyclable back into a respective one or more of the accumulated batches of the macerated and dehydrated food wastes.

6. The process of claim 1, wherein the food wastes that have been macerated and dehydrated have also undergone a biosecurity treatment.

7. The process of claim 1, wherein each of the categorized producers of food waste is selected from: restaurants, cafes, supermarkets, grocers, greengrocers, delicatessens, butchers and bakeries.

8. The process of claim 1, further comprising processing the blended homogenized ingredients into an animal feed in the form of pellets, flakes or mash.

9. The process of claim 1, further comprising adding micro ingredients to the homogenized ingredients.

10. A method for dehydrating a macerated food waste, the method comprising:
mixing into the macerated food waste, proximal to an inlet of a dehydrator, a material having a moisture content that is different to a moisture content of the macerated food waste, wherein the added material and the macerated food waste are mixed such that the mixture at the inlet of the dehydrator has a defined and substantially homogeneous moisture content; and
dehydrating the mixture.

11. The method of claim 10, wherein a quantity of the material added to the macerated food waste is adjustable to achieve the defined moisture content.

12. The method of claim 10, wherein a rate at which the material is added to the macerated food waste is adjustable to achieve the defined moisture content.

13. The method of claim 10, wherein mixing comprises compressing the material and the macerated food waste together.

14. The method of claim 10, wherein a screw auger mixes the added material and the macerated food waste.

15. The method of claim 10, wherein the defined moisture content is about 50% (w/w).

16. (canceled)

17. (canceled)

18. The method of claim 10, further comprising measuring a moisture content of the dehydrated mixture.

19. The method of claim 18, wherein operational parameters of the dehydrator are adjustable based on the measured moisture content of the dehydrated mixture.

20. The method of claim 19, wherein the operational parameters are selected from one or more of: a temperature of the dehydrator, a feed rate into the dehydrator and a residence time in the dehydrator.

21. (canceled)

22. (canceled)

23. The method of claim 10, wherein a relatively dry material is added into a relatively wet macerated food waste.

24. An apparatus for dehydrating a macerated food waste, the apparatus comprising:
a hopper, an outlet of the hopper reporting to an inlet of a dehydrator;
a moisture detector configured to detect a moisture content proximal to the outlet of the hopper;
a conduit via which a material having a moisture content that is different to the moisture content of the macerated food waste can be added to the macerated food waste proximal to the outlet of the hopper; and
a mixer for mixing the material and the macerated food waste in a manner whereby the resultant mixture presents to the inlet of the dehydrator having a defined and substantially homogeneous moisture content.

25-35. (canceled)
